(19) United States
(12) Patent Application Publication
(10) Pub. No.: US 2026/0062272 A1
(43) Pub. Date: Mar. 5, 2026

(54) BEVERAGE FILLER MANAGEMENT SYSTEM AND METHOD

(71) Applicant: JBT Marel Corporation, Chicago, IL (US)

(72) Inventors: Cezary J. Mroz, Lewis Center, OH (US); Wyatt W. Wills, Newark, OH (US)

(73) Assignee: JBT Marel Corporation, Chicago, IL (US)

(21) Appl. No.: 19/309,009

(22) Filed: Aug. 25, 2025

Related U.S. Application Data
(60) Provisional application No. 63/689,453, filed on Aug. 30, 2024.

(51) Int. Cl. B67C 3/00; B67C 7/00

(52) U.S. Cl. CPC B67C 3/007; B67C 7/004; B67C 2007/006; B67C 2007/0066

(57) ABSTRACT

A beverage packaging component management system may include a component information system configured to obtain component information from a data storage device of a beverage packaging component and write component information to the data storage device regarding component usage. The beverage packaging component management system may include a processor and a memory storing instructions that, when executed by the processor, cause a computing device of the beverage packaging component management system to: process component information including at least one of a beverage packaging component type and component usage; and output a component optimization plan including at least one of recommendations and instructions for using a first type of beverage packaging component for packaging beverages having first beverage packaging requirements, replacing the beverage packaging component, verifying the beverage packaging component on the beverage packaging machine, adjusting one or more beverage packaging components, and adjusting beverage packaging machine settings.

### CROSS-REFERENCE TO RELATED APPLICATION

This application claims the benefit of U.S. Provisional Application No. 63/689,453, filed Aug. 30, 2024, the entire contents of which are incorporated herein by reference.

### BACKGROUND

Beverages are typically packaged into cans, bottles (glass or plastic) and other containers using high speed filling systems. Containers are conveyed to a filling machine where a product blend (e.g., water and syrup) is dispensed into individual containers that are then sealed (e.g., a lid or cap is joined to the filled container). These processes are usually performed at high speeds, requiring precise control of various parameters such that even a small deviation in one process condition can reduce throughput or result in deleterious effects on the packaged beverage. For instance, components of the filler must be specifically configured and managed for containers of a specific size, shape, etc.

Improved systems and methods for high-speed filling are described herein.

### SUMMARY

In some aspects, the techniques described herein relate to a beverage packaging component management system for managing beverage packaging component use for a beverage packaging machine, including: a component information system configured to obtain component information from a data storage device of a beverage packaging component and write component information to the data storage device regarding component usage; a processor; and a memory storing instructions that, when executed by the processor, cause a computing device of the beverage packaging component management system to: process component information including at least one of a beverage packaging component type and component usage; and output a component optimization plan including at least one of recommendations and instructions for using a first type of beverage packaging component for packaging beverages having first beverage packaging requirements, replacing the beverage packaging component, verifying the beverage packaging component on the beverage packaging machine, adjusting one or more beverage packaging components, and adjusting beverage packaging machine settings.

In some aspects, the techniques described herein relate to a beverage packaging component management system, including: a beverage packaging machine, including: a processing station for packaging beverages; a container transportation system having a beverage packaging container transport component configured to support movement of containers within the beverage packaging machine; and a component information system configured for obtaining component information from a data storage device of the beverage packaging container transport component and writing component information to the data storage device regarding component usage; a processor; and a memory storing instructions that, when executed by the processor, cause a computing device of the beverage packaging component management system to: process component information including at least one of a beverage packaging component type and component usage; and output a component optimization plan including at least one of recommendations and instructions for using a first type of beverage packaging component for packaging beverages having first beverage packaging requirements, replacing the beverage packaging component, verifying the beverage packaging component on the beverage packaging machine, adjusting one or more beverage packaging components, and adjusting beverage packaging machine settings.

In some aspects, the techniques described herein relate to a method for managing beverage packaging components for a beverage packaging machine, including: obtaining, with a component information system, component information from a data storage device of a beverage packaging component; writing, with the component information system, component information to the data storage device regarding component usage; processing, with a computing device, component information including at least one of a component type and component usage; and outputting, with a computing device, a component optimization plan including at least one of recommendations and instructions for using a first type of beverage packaging component for packaging beverages having first beverage packaging requirements, replacing the beverage packaging component, verifying the beverage packaging component on the beverage packaging machine, adjusting one or more beverage packaging components, and adjusting beverage packaging machine settings.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an isometric view of an exemplary canned beverage filling machine.

FIG. 2 is an isometric view of a portion of the exemplary canned beverage filling machine of FIG. 1.

FIG. 3 is an isometric view of an exemplary infeed assembly of a canned beverage filling machine.

FIG. 4 is an isometric exploded view of the exemplary infeed assembly of FIG. 3.

FIG. 5 is an isometric view of an infeed star subassembly of the exemplary infeed assembly of FIG. 3.

FIG. 6 is an isometric view of a J-rail subassembly of the exemplary infeed assembly of FIG. 3.

FIG. 7 is an isometric view of an infeed wiper subassembly of the exemplary infeed assembly of FIG. 3.

FIG. 8 is an isometric view of a back guide subassembly of the exemplary infeed assembly of FIG. 3.

FIG. 9 is a top view of an infeed assembly, a rotary filling system, a transfer assembly, a first discharge guide assembly, and a second discharge guide assembly of an exemplary bottle beverage filling machine showing a bottle path through the assemblies.

FIG. 10 is a block diagram of a non-limiting example of a beverage packaging machine component management system.

FIG. 11 is a block diagram of a non-limiting example of a beverage packaging machine component optimization computing device for use in the beverage packaging machine component management system.

FIG. 12 is a flowchart of a non-limiting example of a method of managing components for a beverage packaging machine.

FIG. 13 is a block diagram that illustrates a non-limiting example of a computing device appropriate for use as a computing device with examples of the present disclosure.

### DETAILED DESCRIPTION

Canned and bottled beverages are packaged in a wide variety of can and bottle sizes and shapes, and many packaging plants fill multiple sizes of cans and bottles from one day to the next, or even within a single day. Each can or bottle size/shape change typically necessitates stopping packaging while various can or bottle feed changeover components (e.g., guide rails, rotating turrets, etc.), and other assemblies of the packaging line are either adjusted for the new can or bottle size/shape or replaced with the appropriately sized and configured changeover components. This is a time-consuming process that limits production. Moreover, all the necessary changeover components must be adjusted or changed at the same time to accommodate a different can or bottle size/shape. This process is currently managed manually and is prone to operator error. One missing changeover component can cause packaging machine failure.

High-speed beverage filling and container closure machines also use many components that require periodic maintenance and/or replacement due to wear and tear. The components related to a changeover of a can or bottle (e.g., due to size and/or shape of the can/bottle) can require maintenance and/or replacement at different times. Preferably, machine operators want to use machine components for as long as they can successfully be used because each part replacement is a cost to the packaging process. Thus, although it would simplify operations management to maintain and/or replace all the components for a specific type of changeover as a group, it is not a cost-effective method for managing machine components.

Systems and methods disclosed herein relate to high-speed beverage packaging machine component tracking, management, and use optimization. Using the systems and methods disclosed herein, changeover components may be more reliably and efficiently managed for a changeover of a high-speed beverage packaging machine to support a new type or size of container. Moreover, the systems and methods disclosed herein can be used to optimize the maintenance and/or repair management of high-speed beverage packaging machine components. Other benefits of the systems and methods disclosed herein will also become appreciated from the descriptions and illustrations provided herein.

Aspects of the disclosed systems and methods will be described with reference to a mechanical high-speed filling machine. However, it should be appreciated that the disclosed systems and methods may be used with any suitable high-speed filling machine, such as an electronic volumetric high-speed filling. Further, the disclosed systems and methods may be used with other machines related to high-speed filling, such as a can seamer or other container closure machine.

Moreover, the disclosed systems and methods, though sometimes described with specific applicability to beverage containers, may also be used outside of the beverage area. Accordingly, it is to be understood that references to “beverage container”, “drink container”, etc., also include non-potable liquid containers.

As noted above, the disclosed systems and methods may be used with any suitable high-speed filling machine generally configured to carry out the filling of a beverage container, such as a bottle, a can, etc. Any suitable assemblies and components, including the arrangement of assemblies and components, may be used. In some examples, the high-speed filling machine is a Bevcorp mechanical rotary filler or a Bevcorp electronic volumetric high-speed filler available from JBT Marel Corporation. For instance, the disclosed systems and methods may be used with the JBT Marel Bevcorp EV-2736.096 model.

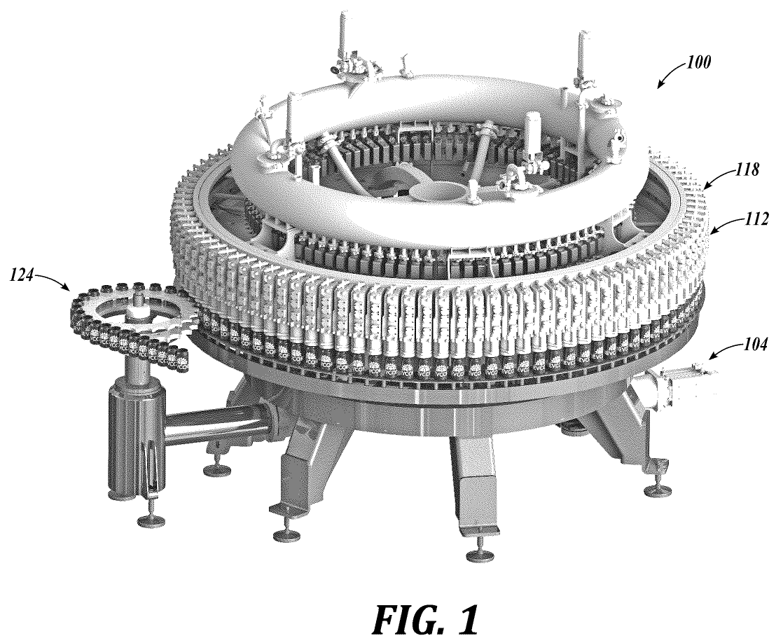

FIG. 1 depicts an exemplary, representative high-speed beverage filling machine 100 that may be used with the disclosed systems and methods. In basic form, the filler machine 100 includes a frame 104 for supporting a revolving or rotary filling system having a rotating carriage 112 that revolves around a central, vertical carriage axis. The rotating carriage 112 is designed to receive and hold bottles or cans C as shown for filling at a plurality of filling positions located about the periphery of the rotating carriage 112. At each of the filling positions is located a filling arrangement 118 having at least one filling device, element, apparatus, valve, etc., in communication with a beverage supply. The filling arrangements 118 are designed to introduce a predetermined volume or amount of liquid beverage into the interior of the cans C to a predetermined or desired level.

The high-speed beverage filling machine 100 includes an infeed assembly that is configured to transition an often bulk supply of empty containers (such as from an infeed table or beverage packaging) to an organized, continuous supply of singulated empty containers. The infeed assembly may include one or more motorized turrets and/or star wheels shaped to receive a single empty container, such as a can, in individual pockets defined around its circumference. The empty containers are moved about the periphery of the motorized turrets and/or the star wheels, typically against a counter force of one or more guide rails, and transported to another portion of the filling machine.

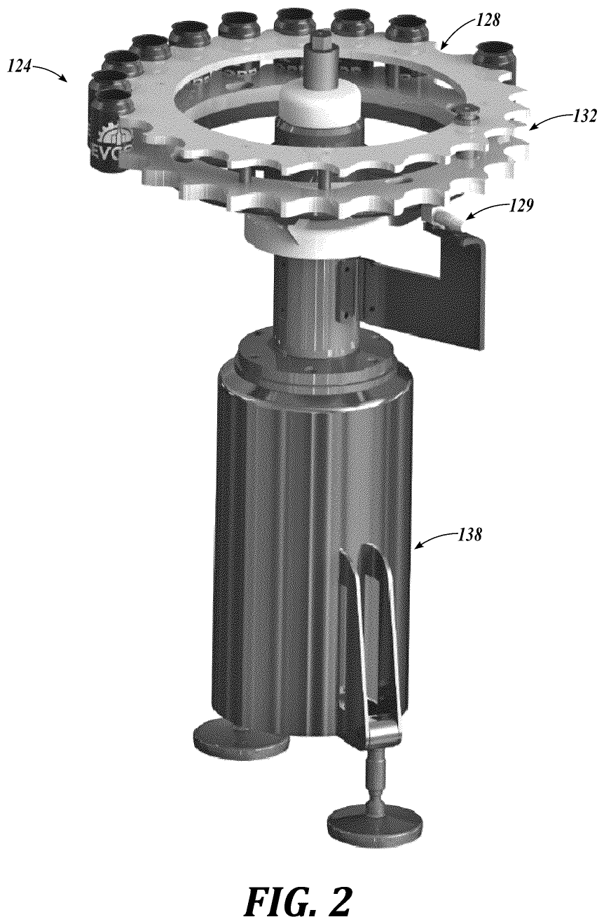

The exemplary, representative high-speed beverage filling machine 100 includes an infeed assembly 124, shown in isolation in FIG. 2. In the depicted example, the infeed assembly 124 is configured, at least in part, as a motorized turret assembly having upper and lower turrets 128 and 132 powered by a motor 138. Each of the upper and lower turrets 128 and 132 have circumferential, aligned container pockets that each receive a single empty container, such as a can C. The upper and lower turrets 128 and 132 rotate in unison to feed singulated, empty cans C to the rotating carriage 112 of the rotary filling system for carrying out the filling process.

It can be appreciated that the pocket size and/or shape of the upper and lower turrets 128 and 132 is specific to the size and/or type of container. In that regard, when the container size and/or type needs to be changed, such as for a new production run, the upper and lower turrets 128 and 132 may also need to be changed. Moreover, the upper and lower turrets 128 and 132, or any components operatively securely the turrets to the motor 138, periodically need to be changed due to wear and tear. Wear and tear of the turrets or supporting components can cause the infeed assembly to malfunction.

An outfeed assembly of a high-speed beverage filling machine may include similar components configured to transport or more filled containers from the filling machine to a downstream machine, such as a container closure machine. The container closure machine may be a can seamer, a bottle capping machine, etc. The container closure machine may similarly include infeed and outfeed assemblies configured to transport filled containers to and from the machine. For instance, the container closure machine may include infeed components shown and described in U.S. Patent Pub. Nos. US20240228176A9 and US20240228092A9, entitled “Quick change guide rail assemblies” and “Turret assemblies for container sealing system”, respectively, the disclosures of which are hereby incorporated by reference herein in their entireties.

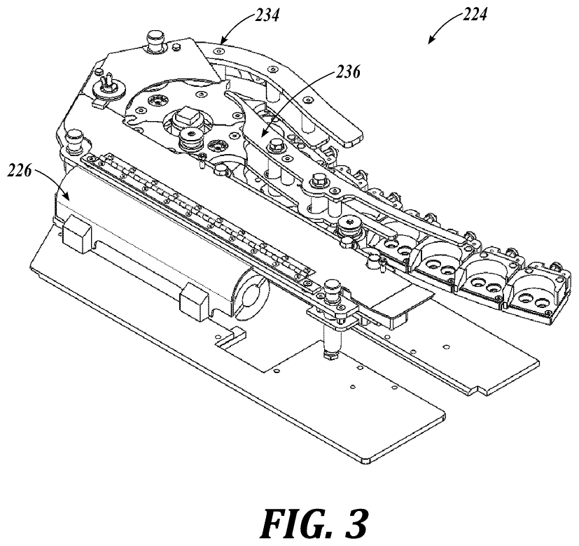

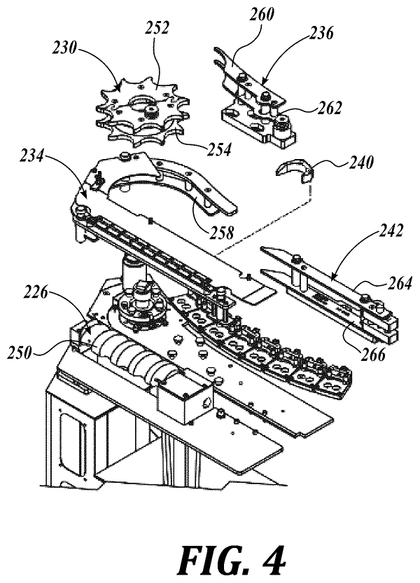

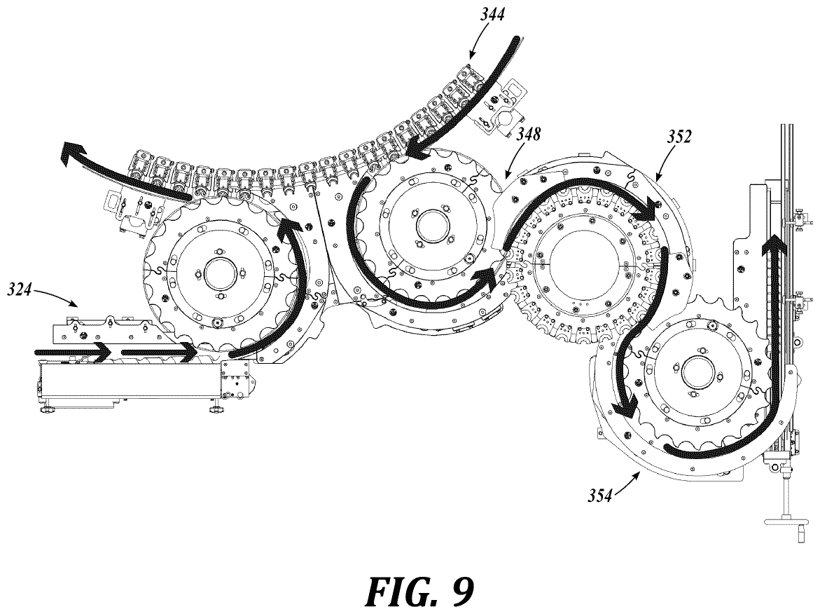

Another example of an infeed assembly 224 for use with a high-speed beverage filling machine is shown in FIGS. 3 and 4. The infeed assembly 224 includes an infeed worm subassembly 226, an infeed star subassembly 230, a j-rail subassembly 234, an infeed wiper subassembly 236, a centering guide subassembly 240, and a back guide subassembly 242. Each of these listed subassemblies of the infeed assembly 224 are configured for cooperatively feeding, at least in part, a certain size and/or type of container to a revolving or rotary filling system of a high-speed beverage filling machine. In the example shown, the infeed assembly 224 is generally configured for feeding cans to a rotary filling system. An exemplary infeed assembly 324 for feeding bottles to a rotary filling system will be described below with reference to FIG. 9.

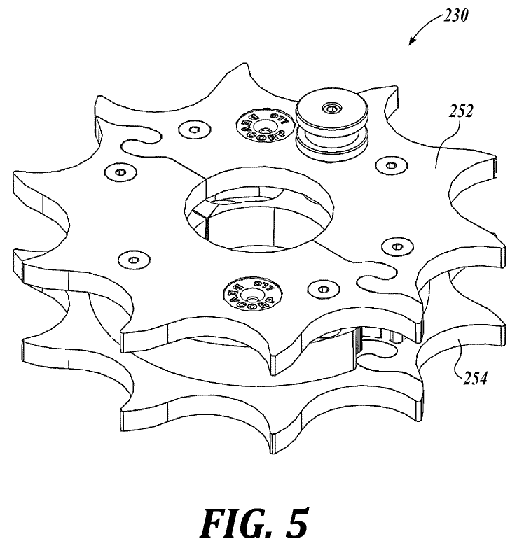

The various subassemblies of the infeed assembly 224 will now be described, starting with the infeed worm subassembly 226 shown in FIGS. 3 and 4 and the infeed star subassembly 230 shown in detail in FIGS. 4 and 5. The infeed worm subassembly 226 includes a motorized infeed worm 250 generally in the configuration of an auger. The infeed worm 250 includes a helical groove sized and shaped to receive and move cans along its length as it rotates about its longitudinal axis. The infeed worm 250 must be changed to support different size or types of cans, such as for a new production run. In addition, components of the infeed worm subassembly 226, including the infeed worm 250 must be changed to accommodate wear and tear.

The infeed star subassembly 230 is generally configured to take the cans from the infeed worm subassembly 226 and rotate the cans clockwise. In that regard, the infeed star subassembly 230 includes top and bottom infeed stars 252 and 254 secured together and spaced apart with a suitable star mounting and pin assembly. The infeed stars 252 and 254 include circumferential, aligned pockets that each receive a single empty container, such as a can. As noted above, the infeed stars 252 and 254 take the cans from the infeed worm subassembly 226 drive the cans toward the rotary filling system while maintaining proper can spacing determined by the helical configuration of the infeed worm 250. The infeed stars 252 and 254 must be changed to support different size or types of cans, such as for a new production run. In addition, components of the infeed star subassembly 230 may need to be changed to accommodate wear and tear of the components.

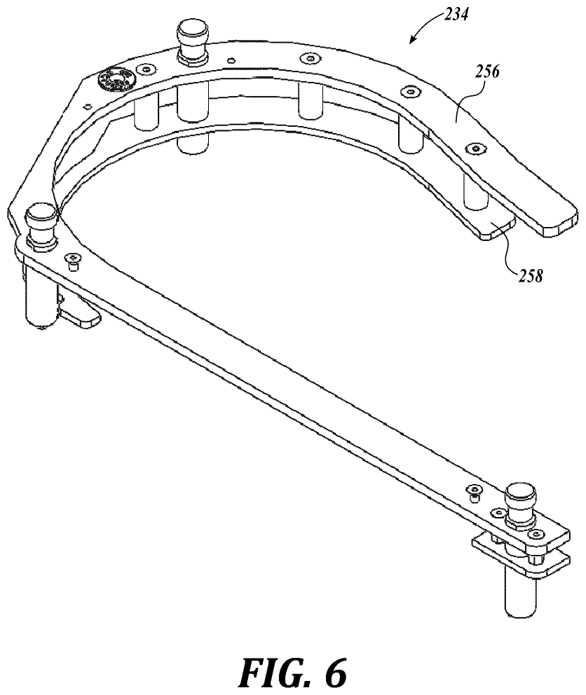

The j-rail subassembly 234, which is shown in detail in FIG. 6, is generally configured to define an outside guide around the infeed star subassembly 230 along which the cans may move. In that regard, the j-rail subassembly 234 includes at least upper and lower J-shaped guide rails 256 and 258 secured together and spaced apart with a suitable mounting assembly. The J-shaped guide rails 256 and 258 support the empty can traveling along the infeed worm subassembly 226 and the infeed star subassembly 230 until the can is transferred onto a rotary carriage for filling. A can cover may also be attached to the j-rail subassembly 234 for preventing debris from getting into a top open end of the can before it is introduced to a filling valve. The J-shaped guide rails 256 and 258 may need to be changed or adjusted to support different size or types of cans, such as for a new production run. In addition, components of the j-rail subassembly 234 may need to be changed to accommodate wear and tear of the components.

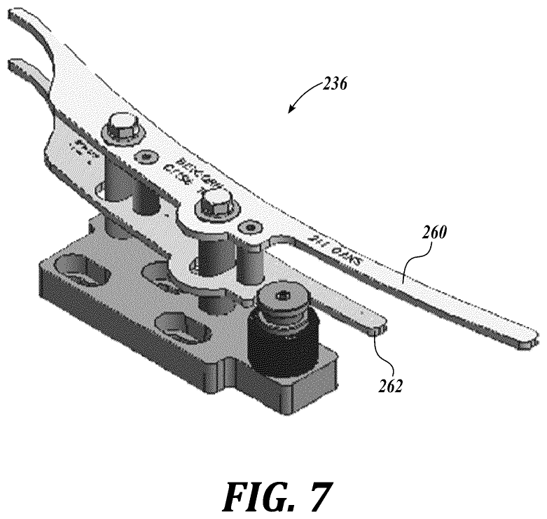

The infeed wiper subassembly 236, which is shown in detail in FIG. 7, is generally configured to support the cans as they are being transferred into the rotary filling system. The infeed wiper subassembly 236 includes upper and lower elongated wipers 260 and 262 that are secured together and spaced apart with a suitable mounting assembly. The upper and lower elongated wipers 260 and 262 interweave with the infeed stars 252 and 254 and help to move the can out of the infeed star subassembly 230 and into the rotary filling system. The upper and lower elongated wipers 260 and 262 may need to be changed or adjusted to support different size or types of cans, such as for a new production run. In addition, components of the infeed wiper subassembly 236 may need to be changed to accommodate wear and tear of the components.

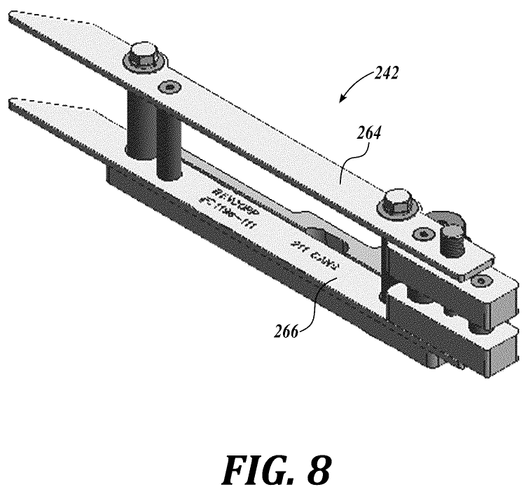

The back guide subassembly 242, which is shown in detail in FIG. 8, is generally configured to support the can while it is being pushed through the infeed worm subassembly 226, preventing double feeds of the incoming cans. The back guide subassembly 242 includes top and bottom guide rails 264 and 266 that are secured together and spaced apart with a suitable mounting assembly. The top and bottom guide rails 264 and 266 support the can from an end of an infeed table or beverage packaging all the way through to the infeed star subassembly 230. The top and bottom guide rails 264 and 266 may need to be changed or adjusted to support different size or types of cans, such as for a new production run. In addition, components of the back guide subassembly 242 may need to be changed to accommodate wear and tear of the components.

The exemplary infeed assembly 324 for feeding bottles to a rotary filling system of a high-speed beverage filling machine will now be described with reference to FIG. 9. The infeed assembly 324 includes an infeed worm subassembly, an infeed star subassembly, an infeed wiper subassembly, and an infeed guide subassembly, among other components. Like the infeed assembly 224 described above, each of these listed subassemblies of the infeed assembly 324 are configured for cooperatively feeding, at least in part, a certain size and/or type of container to a revolving or rotary filling system of a high-speed beverage filling machine. In the example shown, the infeed assembly 324 is generally configured for feeding bottles to a rotary filling system.

The infeed worm subassembly, infeed star subassembly, infeed wiper subassembly, and infeed guide subassembly of the infeed assembly 324 include components similar to those described above with respect to the infeed worm subassembly 226, infeed star subassembly 230, infeed wiper subassembly 236, and back guide subassembly 242, respectively, although adapted for transporting bottles. Thus, detailed aspects of the infeed assembly 324 will not be provided for brevity. It can be appreciated that components of the infeed assembly 324, like that for the infeed assembly 224, may need to be changed or adjusted to support different size or types of bottles, such as for a new production run. In addition, components of the infeed assembly 324 may need to be changed to accommodate wear and tear of the components.

The infeed assembly 324 transports bottles to a rotary filling system 344 moving in a rotary direction opposite of the infeed assembly 324. After being filled along the rotary path of the rotary filling system 344, the bottles are moved into a transfer assembly 348 moving in a rotary direction opposite of the rotary filling system 344. The bottles are then transferred to a first discharge guide assembly 352 moving in a rotary direction opposite of the transfer assembly 348 and then to a second discharge guide assembly 354 moving in a rotary direction opposite of the first discharge guide assembly 352. A bottle path through the various assemblies is shown in FIG. 9.

A turret or star assembly for one or more of the infeed assembly 324, the transfer assembly 348, the first discharge guide assembly 352, and the second discharge guide assembly 354 may generally include one or more stars having circumferential, aligned pockets that each receive a single bottle. The stars may be secured together and spaced apart with a suitable star mounting and pin assembly. The stars may need to be changed or adjusted to support different size or types of bottles, such as for a new production run. In addition, components of the star assembly may need to be changed to accommodate wear and tear of the components.

A capper neck star assembly may be used for the rotary filling system 344. The capper neck star assembly may include a plurality of circumferentially arranged quick change neck top elements configured to each receive a neck of a single bottle. The neck top elements may be secured together and spaced apart with a suitable plate mounting and pin assembly. The neck top elements may need to be changed or adjusted to support different sizes or types of bottles, such as for a new production run. In addition, components of the capper neck star assembly may need to be changed to accommodate wear and tear of the components.

A bottle support assembly for the rotary filling system 344 may include a necktop positioned above and spaced apart from a backrest. The necktop may be configured to receive a neck of a single bottle, and the backrest my be configured to receive the body of the bottle. The necktop and backrest may need to be changed or adjusted to support different size or types of bottles, such as for a new production run. In addition, components of the necktop and backrest may need to be changed to accommodate wear and tear of the components.

As can be appreciated from the above, components of infeed, transfer, and outfeed assemblies of high-speed filling machines and container closure machines need to be coordinated for changeovers and machine maintenance. In that regard, there is a need to track components when changing the machine over to support different container sizes and/or types. All the components necessary to support a specific container size and/or type must be correctly changed over and/or adjusted before the machine can be used to fill or close the container. For instance, if a star assembly is changed over to support a smaller container size, but the corresponding guide rails, wipers, etc. are not changed over, the container will not be appropriately secured within its travel path defined by the star assembly and the corresponding guide rails, wipers, etc. Further, if a component has significant wear and tear and cannot function properly within the assembly, the container will again not be appropriately secured within its travel path.

Using the systems and methods disclosed herein, components may be more reliably and efficiently managed for a changeover of a high-speed beverage packaging machine, such as a filling and/or closure machine, to support a new type or size of container. Moreover, the systems and methods disclosed herein can be used to optimize the maintenance and/or repair management of high-speed beverage packaging machine components.

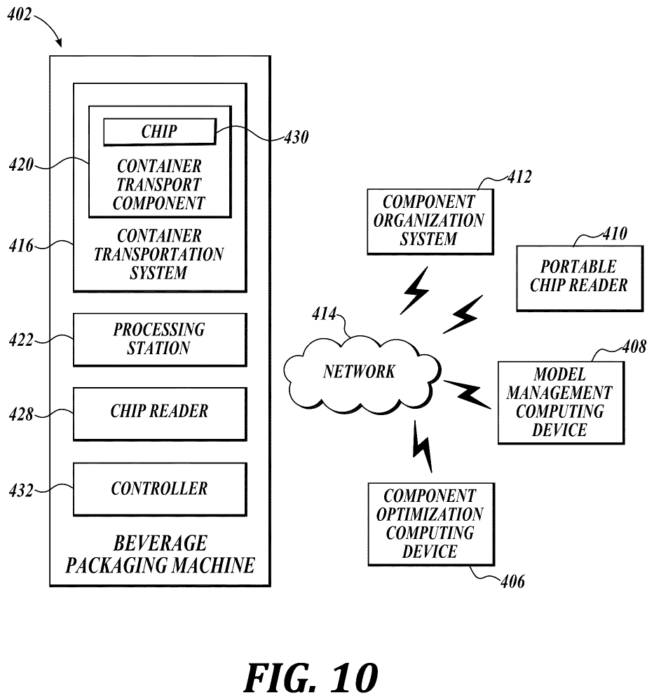

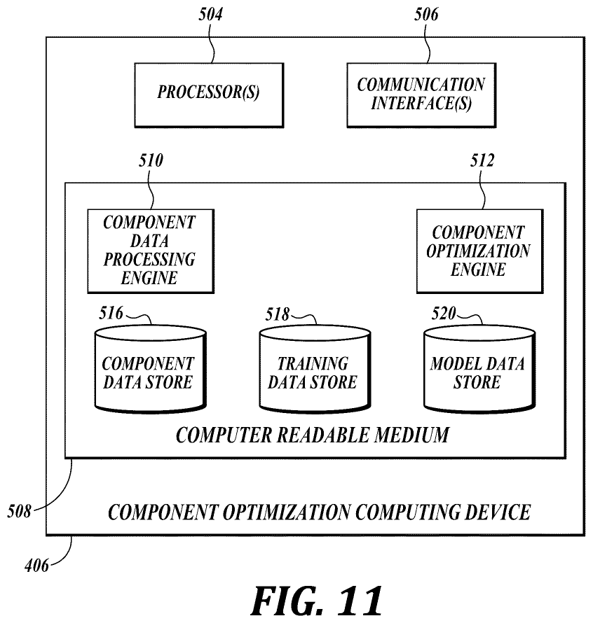

A filler component management system 402 suitable for tracking and managing one or more physical parameters of a filler component, such as its type, wear, etc., will now be described with reference to FIGS. 10 and 11. The filler component management system 402 may be used to optimize filler component use for a machine(s), such as a high-speed beverage filling machine as described herein. However, as noted above, the filler component management system 402 may be adapted for use with any machine that uses similar components, such as container closure machines. Thus, the descriptions and illustrations provided herein should not be seen as limiting.

FIG. 10 depicts a block diagram of a non-limiting example of the filler component management system 402. The filler component management system 402 may include various components and networked computing devices configured for managing aspects of filler component use, such as one or more of the filler infeed, transfer, and outfeed components described herein. In the depicted example, the filler component management system 402 includes a beverage packaging machine 404, a component optimization computing device 406, a model management computing device 408, a portable chip reader 410, and a component organization system 412 communicatively coupled together through a network 414. The network 414 can be any kind of network capable of enabling communication between the various components of the filler component management system 402. For example, the network can be a WiFi network.

A general overview of the components of the beverage packaging component management system 402 will first be provided. As noted above, the beverage packaging component management system 402 is generally configured to carry out and manage aspects of beverage packaging component use, including tracking and managing one or more physical parameters of a beverage packaging component, such as its size, type, wear, etc.

The beverage packaging machine 404 used with the beverage packaging component management system 402 may be generally configured to carry out filling and/or closing of a beverage container, such as a bottle, a can, etc. The beverage packaging machine 404 may use one or more components similar to those described herein that are suitable for transporting containers of a specific size and/or type to and/or from a rotary filling system and/or a container closure system. The beverage packaging machine 404 may also be configured to capture data regarding beverage packaging components, such as size, type, and/or wear data. The component optimization computing device 406 may be generally configured to manage aspects of beverage packaging component use, including tracking and managing one or more physical parameters of a beverage packaging component, such as its size, type, wear, etc. The model management computing device 408 may be generally configured to train one or more machine learning models for use in the beverage packaging component management system 402. The portable component reader 410 may be configured to capture data regarding a beverage packaging component, such as size, type, and/or wear data, such as when the component is not installed on the beverage packaging machine 404. The component organization system 412 may be used to store and organize beverage packaging components, such as according to size, type, and/or wear, for use on the beverage packaging machine 404 or other similar machines.

It should be appreciated that any of the techniques described herein may be carried out by any suitable computing device(s) and should not be limited to the specific configurations provided herein. For instance, some or all of the techniques described herein may be carried out by the component optimization computing device 406 or another computing device. Thus, the examples and techniques discussed herein should not be seen as limiting.

In the depicted exemplary block diagram of FIG. 10, the beverage packaging machine 404 includes a container transportation system 416 having one or more container transport components 420 configured to support movement of a specific container size and/or shape within the beverage packaging machine 404. The beverage packaging machine 404 further includes a processing station 422, such as a rotary filling system or a container closure system. The beverage packaging machine 404 further includes a beverage packaging component information system including a beverage packaging component data storage device (e.g., tag or chip) reader 428 and a data storage device associated with each of the one or more container transport components, such as a chip 430. The various components of the beverage packaging machine 404 may be controlled by a controller 432.

The container transport component 420 includes a data storage device or chip 430 that is configured to support identification of and tracking of the container transport component 420. For instance, the chip 430 may be an RFID tag configured to store numeric or binary data related to the component identification, use, and/or wear. The chip 430 may be readable and writable by the chip reader 428, which may be a suitable sensor device, such as an RFID reader.

The chip 430 may be secured to or within the container transport component 420 in any suitable manner such that it is readable and writable by the chip reader 428 at predefined intervals, such as once per turret or star revolution. In the case of an infeed, transfer, or discharge/outfeed star, the chip 430 may be integrated or embedded within the body of the star during the molding or forming process. In some examples, the chip 430 may be secured to the beverage packaging component in a secure manner so as to substantially prevent tampering with the chip. In any event, the chip 430 may be located on the container transport component 420 such that it is within proximity to the chip reader 428 for reading/writing to the chip, such as at the predefined intervals. In some examples, the chip reader 428 may be positioned on the frame of the beverage packaging machine 404 (e.g., see frame 104 in FIG. 1) in proximity to the beverage packaging component having the chip 430. In the example shown in FIG. 1, a chip reader 129 is secured to a bracket of the infeed assembly 124 such that it may read/write to a chip secured to one or more of the upper and lower turrets 128 and 132 at each revolution of the turret(s).

For beverage packaging components that do not move within the beverage packaging machine 404 and therefore cannot pass the chip reader 428 to track wear/usage, in some examples the chip 430 may be readable/writable by the portable component reader 410. In some examples wear/usage data for stationary beverage packaging components may instead be tied to the wear/usage data for the movable parts in that subassembly. For instance, wear/usage of the j-rail subassembly 234, infeed wiper subassembly 236, centering guide subassembly 240, and back guide subassembly 242 of the infeed assembly 224 may be tied to wear/usage data of one or more of the infeed worm subassembly 226 and infeed star subassembly 230 of the same infeed assembly 224.

In any event, the chip reader 428 may include suitable processing capabilities to read information stored on the chip 430, such as information that identifies the type of component (e.g., can or bottle type compatibility, can or bottle size compatibility, manufacturer, machine compatibility, etc.), the component usage or wear (e.g., the number of processing revolutions or uses), or other data. The component information may be sent from the chip reader 428 to the controller 432 or another computing device for managing or tracking aspects of container processing and/or component use. For instance, the component information may be sent to the filler management computing device 406 for processing.

The chip reader 428 may also include suitable processing capabilities for writing information to the chip 430 for managing or tracking aspects of container processing and/or component use. For instance, in the example of a turret, star, or similar component that completes a revolution during beverage processing, the chip reader 428 may output a signal(s) to the chip 430 each time the container transport component 420 completes a revolution and the chip is read by the reader. The signal(s) sent from the chip reader 428 to the chip 430 may be indicative of the “component usage count”, or the cumulative number of component revolutions. In that regard, the chip reader 428 may read a component use count from the chip 430 and may write or output a signal to the chip to index the component use count. The output signals of the chip reader 428 may be in numeric format, binary format, or another suitable format.

In some examples, the beverage packaging component management system 402 includes a portable component reader 410, as noted above. The portable component reader 410 may be configured to read and write information to the chip 430, regardless of whether the container transport component 420 is installed on the machine or whether the component can move past the chip reader 428. For instance, the portable component reader 410 may be used to check type and/or wear data of components that are not in use (e.g., components that are being stored on a board or in a storage portion of the component organization system 412). The portable component reader 410 may be used to check type and/or wear data of components that are installed on the machine but that do not move past the chip reader 428. The portable component reader 410 may have the same or similar processing capabilities as the chip reader 428 described above, with the ability to communicate wirelessly with other components of the beverage packaging component management system 402, such as the filler management computing device 406.

The processing station 422 may be any suitable system that is associated with one or more container transport components 420 for supporting beverage packaging processing tasks. In the examples described herein, the processing station 422 may be a rotary filling system, a container closure (e.g., seamer) system, etc. Thus, processing by the processing station 422 is related to or affected by container transport component size, type, wear, etc.

The controller 432 may be used to control one or more components of the processing station 422 and the container transportation system 416. For instance, the controller 432 may be used to control a beverage packaging speed, such as a filling speed of the processing station 422 and/or a container transport speed of the container transportation system 416 based on predetermined criteria or requirements for the beverage packaging. The container transportation component speed may depend on the type of component(s) in use, the wear of the component(s), the beverage packaging needs (e.g., type and/or size of the containers, the beverage recipe, etc.), or other factors. The controller 432 may output signals to the beverage packaging machine components to carry out instructions sent from one or more other computing devices, such as the filler management computing device 406.

Referring to the block diagram shown in FIG. 11, exemplary aspects of the component optimization computing device 406 will now be described. In the exemplary block diagram of FIG. 11, the component optimization computing device 406 includes a processor(s) 504, a communication interface(s) 506, computer readable medium 508, and at least one data store (e.g., component data store 516, training data store 518, and model data store 520). As shown, the computer readable medium 508 has stored thereon logic that, in response to execution by the one or more processor(s) 504, cause the component optimization computing device 406 to provide a component data processing engine 510 and a component optimization engine 512.

The component optimization computing device 406 may be implemented by any computing device or collection of computing devices, including but not limited to a desktop computing device, a laptop computing device, a mobile computing device, an edge computing device, a server computing device, a computing device of a cloud computing system, and/or combinations thereof. In some examples, the processor(s) 504 may include any suitable type of general-purpose computer processor. In some examples, the processor(s) 504 may include one or more special-purpose computer processors or AI accelerators optimized for specific computing tasks, including but not limited to graphical processing units (GPUs), vision processing units (VPTs), and tensor processing units (TPUs).

In some examples, the communication interface(s) 506 includes one or more hardware and or software interfaces suitable for providing communication links between components. The communication interface(s) 506 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

The component data processing engine 510 of the component optimization computing device 406 may be configured to pre-process incoming data for a container transport component 420 and any related data. The data may include component identification information (e.g., can or bottle type compatibility, can or bottle size compatibility, manufacturer, machine compatibility, etc.) and component usage data (e.g., component count or cumulative number of processing revolutions). Such data may be retrieved from or sent from the component reader 428 and/or the portable component reader 410. The related data may include data pertaining to the beverages to be packaged, such as the beverage recipe, the availability of the type or size of the containers, etc. Pre-processing of the data may include extracting relevant information, correlating information, compressing data size, scrubbing the data, etc. Such pre-processed data may be stored in the component data store 516 for later retrieval.

The data received and pre-processed by the component data processing engine 510 may be sent to or retrieved by the component optimization engine 512, which may use the data to determine any component management recommendations or instructions. The component management recommendations or instructions may relate to use of a certain component, replacement of a component, verification of a component on the beverage packaging machine 404, adjustments to components or settings of the beverage packaging machine 404, etc. The component optimization engine 512 may output instructions to the controller 432 of the beverage packaging machine 404 for automatically or semi-automatically carrying out an action according to the instructions, and/or the component optimization engine 512 may output a recommendation on a display associated with the component optimization computing device 406 and/or the beverage packaging machine 404 such that an operator may carry out any necessary actions.

In some examples, the component management recommendations or instructions may include a recommendation to use a first component of a first type (e.g., having a first component configuration or profile (e.g., container pocket shape) and/or a first wear level (e.g., component count)) to package beverages of a first type. As can be appreciated, the component type and the component usage or wear level can substantially affect the efficiency and quality of beverage packaging.

In the case of beverage packaging, certain components must be used together to process containers of a certain size and/or type. The component optimization engine 542 may output a recommendation to use a collection or group of component of a certain subassembly to package a beverage in a selected type or size of container (e.g., based on operator input, a packaged beverage supply/demand engine, etc.). For instance, the component optimization engine 512 may output a recommendation to use a specific infeed worm, a specific infeed star, specific j-shaped guide rails, specific elongated wipers, and specific guide rails to configure an infeed assembly for a high-speed filling machine to correctly feed a selected container into the filling machine. As noted above, all the components of an infeed assembly tied to a specific container size and/or type must be used together in an infeed assembly to properly function.

The component optimization engine 512 may output a recommendation to use a component of a certain wear or usage level to package a beverage in a selected type or size of container (e.g., based on operator input, a packaged beverage supply/demand engine, etc.). If features of a feed component are worn, the gap between the outer surface of neighboring components will increase. Accordingly, the worn component may be more appropriate for managing containers of a different type or may need to be replaced or repaired. For instance, a turret or star having an outer contour like that shown in FIGS. 2, 5, 6, and/or 15 that is near the end of its life cycle (higher wear level) may be appropriate for transporting containers of a larger size. Thus, the recommendation of the component optimization engine 512 may tailor a wear or usage level of a component to a specific processing application.

In some examples, the component optimization engine 512 may output recommendations or instructions to replace a component within a certain number of uses or counts and/or recommendations or instructions for ordering a replacement component. At some point, a component may become so worn that it is no longer adequate to support beverage packaging. The threshold usage level or component count may be determined by calculating component counts of components previously used on the beverage packaging machine 404. If the component is an endless, continuous loop component with a known length or circumference, the component count for a worn component can be determined over its lifetime of use. Moreover, as noted above, if the component is a stationary component, the component count can be based on the usage data for the continuous loop component.

In that regard, the component optimization engine 512 may, based on known usage data for a certain type of component(s), output recommendations or instructions to replace a component(s) within a certain number of component counts. For instance, the component optimization engine 512 may output information indicating that a component count is at 18,000 counts and that the component(s) should be replaced by count 20,000. The information may be displayed on a display associated with the component optimization computing device 406 and/or the beverage packaging machine 404.

In some examples, the component optimization engine 512 may output recommendations or instructions for ordering a replacement component(s). For instance, the component optimization engine 512 may output information regarding a part number for ordering a replacement component(s). In some examples, the component optimization engine 512 may automatically order a replacement component(s), such as by sending an electronic order to a digital order platform of the component supplier or manufacturer. In some examples, the component optimization engine 512 may determine an optimal time for ordering two or more replacement components (e.g., a bulk order) based on wear data and expected usage for the two or more components. For instance, if a first component is 60% worn and a second component is 80% worn but used less frequently than the first component, the component optimization engine 512 may place a replacement order for both components when the first component is 80% used.

In some examples, the component optimization engine 512 may execute one or more component optimization machine learning models suitable for outputting a component optimization plan regarding component replacement. The component optimization plan may include recommendations or instructions to replace a component(s) of a certain wear or usage level. In that regard, input for the component optimization machine learning model(s) may include at least one of component identification information (e.g., can or bottle type compatibility, can or bottle size compatibility, manufacturer, machine compatibility, etc.), component usage data (e.g., component count or cumulative number of processing revolutions), and beverage packaging needs (e.g., type and/or size of a container, beverage recipe, etc.). The component optimization machine learning model(s) may be trained using historical or generated data of component replacement schedules correlated to component identification information, usage data, beverage packaging needs, etc.

In some examples, the component optimization engine 512 may output information regarding verification of a component(s) on the beverage packaging machine 404. For instance, the component optimization engine 512 may output information regarding whether the correct style or type of component(s) was chosen for the beverage packaging and/or whether the correct component(s) age was chosen. For instance, if an operator selected a recipe for 16-ounce canned soda, the component optimization engine 512 may output information indicating whether the correct component(s) was chosen, e.g., whether the component(s) has a necessary component outer surface profile, whether the component(s) is from a selected manufacturer, whether the component(s) is above or below a certain usage level, etc. If the installed component(s) does not support the beverage packaging recipe, the component optimization engine 512 may output information indicating such incompatibility.

In some examples, if the installed component does not support the beverage packaging recipe, the component optimization engine 512 may output instructions to the controller 432 of the beverage packaging machine 404 to cause one or more components of the beverage packaging machine 404 to cease functioning, to function in a different manner, etc. For instance, the component optimization engine 512 may output instructions to the controller 432 to cause the beverage packaging machine 404 to stop running the container transportation system 416 and the processing station 422, to run the container transportation system 416 and the processing station 422 at a slower or suboptimal speed or rate, etc., if an incorrect component(s) is used.

In some examples, the component optimization engine 512 may output beverage packaging machine diagnostic information based on information received from the component data processing engine 510. If the container transportation system component is an endless, continuous loop component with a known length or circumference, as with most feed turret or star assemblies, the component data processing engine 510 should receive component count data from the component reader 428 at known time increments when running a drive system (e.g., a VFD) of the container transportation system 416 at a designated speed. For instance, the component reader 428 should read the chip 430 on the container transport component 420 so many times per minute. If the component reader 428 does not receive the expected component count data for a certain period, the component optimization engine 512 may output information indicative of the poor machine performance. In some examples, the component optimization engine 512 may output instructions to the controller 432 to turn off the beverage packaging machine 404 if the component count is off.

In some examples, the component optimization engine 512 may output component management recommendations or instructions for adjusting components or settings of the beverage packaging machine 404 to accommodate components of different configurations or wear. For instance, if features of a feed component are worn, the gap between the outer surface of neighboring components will increase. Accordingly, the worn component may be more appropriate for managing containers of a different type or may need to be replaced or repaired. For instance, a turret or star having an outer contour like that shown in FIGS. 2, 5, and/or 9 that is near the end of its life cycle (higher wear level) may be appropriate for transporting containers of a larger size. Thus, the component optimization engine 512 may output instructions for adjusting the location of a first feed component (e.g., a guide rail) relative to a neighboring component (e.g., a feed star) to decrease or increase the gap for effectively transporting the containers.

In some examples, the component optimization engine 512 may execute one or more component optimization machine learning models suitable for outputting a component optimization plan that includes recommendations or instructions to adjust component(s) or setting(s) of the beverage packaging machine 404 and/or to use a component(s) of a certain wear or usage level to package a selected beverage(s). In that regard, input for the component optimization machine learning model(s) may include at least one of component identification information (e.g., can or bottle type compatibility, can or bottle size compatibility, manufacturer, machine compatibility, etc.), component usage data (e.g., component count or cumulative number of processing revolutions), beverage packaging needs (e.g., type and/or size of a container, beverage recipe, etc.), and machine settings. The component optimization machine learning model(s) may be trained by the model management computing device 408, for example, using historical data of initial and corrected settings used for packaging certain beverages with certain component specifications.

Any relevant training data for the component optimization machine learning model(s) generated by the component optimization computing device 406 may be stored in the training data store 418 of the component optimization computing device 406 and/or a training data store of the model management computing device 408. After being trained at least initially, the component optimization machine learning model(s) may be stored on the model management computing device 408 and retrieved by the component optimization engine 512 for execution, and/or the component optimization machine learning model(s) may be stored locally on the component optimization computing device 406. To support processing of the machine learning models, the component optimization computing device 406 may be configured as a local, high power or edge computing device (e.g., like the data processing computing device described in U.S. Provisional Patent No. 63/588,947).

The model management computing device 408 may also receive or request data regarding beverage packaging machine settings (e.g., from the controller 432), such as the settings of the container transportation system 416 and/or the processing station 422. The machine settings, including an initial setting and any adjusted or corrected settings corresponding to information in component data and/or beverage packaging data or requirements, may be used to train one or more machine learning models to generate a component optimization plan.

In some examples, the component optimization machine learning model(s) may be trained using component optimization score(s). For instance, component optimization score(s) may be correlated to component type and/or wear, incoming container specifications (e.g., type, size, etc.), finished packaged beverage specifications (percentage within spec, yield data, etc.), container transportation system 416 initial and adjusted settings, processing station 422 initial and adjusted settings, etc. For instance, if, based on a first component optimization score for a packaged beverage having first specifications, a component(s) is changed and/or a setting(s) for the container transportation system 416 is adjusted to generate a different packaged beverage result, the container transportation system adjustments can be correlated to the component optimization score(s) for a specific component/container transportation system configuration.

The component or machine setting adjustment data may be derived from operator input in response to a component optimization score output and/or a component optimization plan output from a machine learning model correlated to a score. For example, if an operator receives a component optimization plan including a recommendation for a component(s), component(s) and/or machine setting adjustments (optionally with a score), etc., the operator may accept the recommendation, reject the recommendation, and/or make manual adjustments based on the recommendation. The operator's input can be part of the training data.

Any suitable type of artificial intelligence may be used, including machine learning models that incorporate convolutional neural networks and/or computer vision and/or image segmentation, optionally incorporating deep learning techniques. In one example, the component optimization plan machine learning model may be able to identify separate containers and/or components on the container transportation system 416 (e.g., using optical scan data) by segmenting or “cutting out” an object, feature, etc., in an image. The component optimization plan machine learning model may incorporate the Segment Anything Model (SAM) available from Meta AI, FastSAM from Ultralytics, or another suitable image segmentation model using image segmentation techniques.

Any suitable technique may be used to train the machine learning models, including but not limited to one or more of gradient descent, data augmentation, hyperparameter tuning, and freezing/unfreezing of model architecture layers. In some examples, annotated, raw images are used as the training input. In some examples, one or more features derived from the images, including but not limited to versions of the images in a transformed color space, set of edges detected in the image, one or more statistical calculations regarding the overall content of the images, or other features derived from the images may be used instead of or in addition to the annotated raw images to train the machine learning models

As noted above, the beverage packaging component management system 402 may, in some examples, include a component organization system 412. The component organization system 412 may be configured to store unused components in an organized manner, such as to support easy access to component identification and/or wear data, to assemble the components according to identification and/or wear data, etc. In one non-limiting example, each component may be positionable in a storage location near a chip reader that can display information related to the component, such as identification and/or wear data. In such a system, an operator can quickly and easily identify the recommended component(s) for use in the beverage packaging machine 404. As noted above, a portable component reader 440 may also or instead be used to gain quick access to the component information.

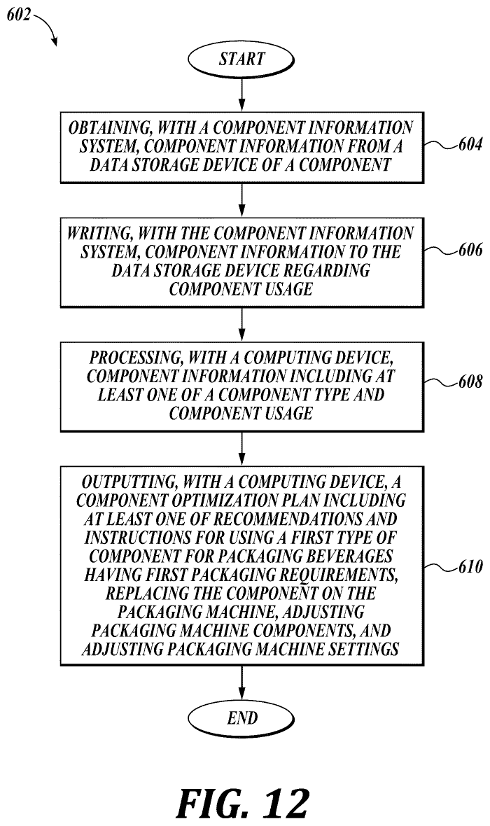

FIG. 12 is a flowchart of a non-limiting example of a method 602 of managing beverage packaging components for a beverage packaging machine. The method 602 may be carried out using any components described herein with reference to the beverage packaging component management system 402, or any other suitable components. Moreover, aspects of the method 602 may be carried out by the controller 432, the component optimization computing device 406, the model management computing device 408, and/or any other suitable computing device.

From a start block, the method 602 may proceed to block 604, which includes obtaining, with a component information system, component information from a data storage device of a beverage packaging component. The component information may include the type of component (e.g., can or bottle type compatibility, can or bottle size compatibility, manufacturer, machine compatibility, etc.), the component usage or wear (e.g., the number of processing revolutions), or other data.

The method 602 may proceed to block 606, which includes writing, with the component information system, component information to the data storage device regarding component usage.

In some aspects, the method includes reading, with an RFID reader (e.g., component reader 428 or portable component reader 410), an RFID tag (e.g., chip 430) secured within the beverage packaging component each time the beverage packaging component completes a cycle in the beverage packaging machine, and writing, with the RFID reader, component usage information pertaining to the beverage packaging component to the RFID tag each time the beverage packaging component completes a cycle in the beverage packaging machine. For instance, the RFID reader may index the component count every time the RFID tag is read.

The method 602 may proceed to block 608, which includes processing, with a computing device, component information including at least one of a component type and component usage. For instance, the information may be pre-processed by the component data processing engine 510 of the component optimization computing device 406 for sending to the component optimization engine 512.

The method 602 may proceed to block 610, which includes outputting, with a computing device (e.g., the component optimization engine 512 of the component optimization computing device 406), a component optimization plan including at least one of recommendations and instructions for using a first type of beverage packaging component(s) for packaging beverages having first packaging requirements, replacing the beverage packaging component(s), verifying the beverage packaging component(s) on the packaging machine, adjusting a packaging machine component(s), and adjusting a packaging machine setting(s), as discussed above. The method 602 may further include executing, with a computing device (e.g., the component optimization engine 512 of the component optimization computing device 406), one or more component optimization machine learning models to output the component optimization plan using at least one of component identification information, component usage data, and beverage packaging needs as input.

The method 602 may further include outputting, with a computing device (e.g., the component optimization engine 512 of the component optimization computing device 406), at least one of recommendations or instructions for adjusting at least one of components and settings of the beverage packaging machine 404 and/or the container transportation system 416 to accommodate a component(s) outer surface profile (e.g., container pocket shape) and a component(s) wear level. For instance, if features of a feed component(s) are worn, the gap between the outer surface of neighboring components will increase. Accordingly, the worn component(s) may be more appropriate for managing containers of a different type or may need to be replaced or repaired. For instance, a turret or star having an outer contour like that shown in FIGS. 2, 5, 6, and/or 15 that is near the end of its life cycle (higher wear level) may be appropriate for transporting containers of a larger size. Thus, the component optimization engine 512 may output instructions for changing over the worn star. In some examples, the component optimization engine 512 may output instructions for adjusting the location of a first feed component (e.g., a guide rail) relative to a neighboring component (e.g., a feed star) to decrease or increase the gap for effectively transporting the containers.

The method 602 may further include executing, with a computing device (e.g., the component optimization engine 512 of the component optimization computing device 406), one or more component optimization machine learning models to output at least one of recommendations or instructions for adjusting at least one of components and settings of the beverage packaging machine 404 and/or the container transportation system 416 using the component outer surface profile and the component wear level as input.

The method 602 may further include determining, with a computing device (e.g., the component optimization engine 512 of the component optimization computing device 406), if a component count is less than an expected component count for a certain period, and outputting, with a computing device (e.g., the component optimization engine 512 of the component optimization computing device 406), instructions to a controller of the beverage packaging machine 404 to at least one of adjust a speed of a container transportation system 416 and processing station 422 and stop the container transportation system and processing station if the component count is less than an expected component count for a certain period.

The method 602 may further include executing, with a computing device (e.g., the component optimization engine 512 of the component optimization computing device 406), one or more component optimization machine learning models to output instructions to a controller of the beverage packaging machine 404 to at least one of adjust a speed of a container transportation system component and stop the container transportation system component using an actual component count and an expected component count for a certain period as input.

Using the systems and methods disclosed herein, changeover components may be more reliably and efficiently managed for a changeover of a high-speed beverage packaging machine to support a new type or size of container. Moreover, the systems and methods disclosed herein can be used to optimize the maintenance and/or repair management of high-speed beverage packaging machine components.

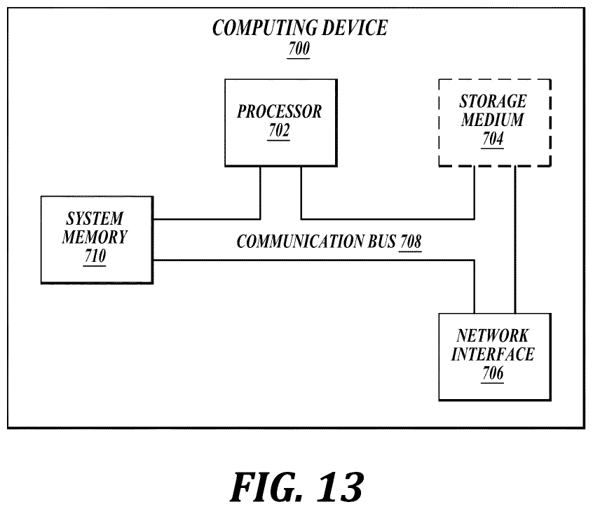

FIG. 13 is a block diagram that illustrates aspects of an exemplary computing device 700 appropriate for use as a computing device of the present disclosure. While multiple different types of computing devices were discussed above, the exemplary computing device 700 describes various elements that are common to many different types of computing devices. While FIG. 13 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 700 may be any one of any number of currently available or yet to be developed devices.

In its most basic configuration, the computing device 700 includes at least one processor 702 and a system memory 710 connected by a communication bus 708. Depending on the exact configuration and type of device, the system memory 710 may be volatile or nonvolatile memory, such as read only memory (“ROM”), random access memory (“RAM”), EEPROM, flash memory, or similar memory technology. Those of ordinary skill in the art and others will recognize that system memory 710 typically stores data and/or program modules that are immediately accessible to and/or currently being operated on by the processor 702. In this regard, the processor 702 may serve as a computational center of the computing device 700 by supporting the execution of instructions.

As further illustrated in FIG. 13, the computing device 700 may include a network interface 706 comprising one or more components for communicating with other devices over a network. Examples of the present disclosure may access basic services that utilize the network interface 706 to perform communications using common network protocols. The network interface 706 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 706 illustrated in FIG. 7 may represent one or more wireless interfaces or physical communication interfaces described and illustrated above with respect to particular components of the computing device 700.

In the example depicted in FIG. 13, the computing device 700 also includes a storage medium 704. However, services may be accessed using a computing device that does not include means for persisting data to a local storage medium. Therefore, the storage medium 704 depicted in FIG. 13 is represented with a dashed line to indicate that the storage medium 704 is optional. In any event, the storage medium 704 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 702, system memory 710, communication bus 708, storage medium 704, and network interface 706 are known and commercially available. For ease of illustration and because it is not important for an understanding of the claimed subject matter, FIG. 13 does not show some of the typical components of many computing devices. In this regard, the computing device 700 may include input devices, such as a keyboard, keypad, mouse, microphone, touch input device, touch screen, tablet, and/or the like. Such input devices may be coupled to the computing device 700 by wired or wireless connections including RF, infrared, serial, parallel, Bluetooth, Bluetooth low energy, USB, or other suitable connections protocols using wireless or physical connections. Similarly, the computing device 700 may also include output devices such as a display, speakers, printer, etc. Since these devices are well known in the art, they are not illustrated or described further herein While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” “an exemplary example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “upstream”, “downstream”, “left”, “right”, “first”, “second”, etc., in the present disclosure is meant to provide orientation for the reader with reference to the drawings and is not intended to be the required orientation of the components or graphical images or to impart orientation limitations into the claims.

In the present disclosure the term “poultry piece” should be understood to include any piece of meat that may be skinned by the automated skin removal machine.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIG. Additionally, the inclusion of a structural or method feature in a particular FIG. is not meant to imply that such feature is required in all examples and, in some examples, it may not be included or may be combined with other features.

Methods according to the above-described examples can be implemented using computer-executable instructions that are stored or otherwise available from computer-readable media of a computing device in communication with the automated skin removal machine. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Systems implementing methods according to this disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example. The instructions, media for conveying such instructions, computing resources for executing them, and other structures for supporting such computing resources are means for providing the functions described in these disclosures.

Various examples of the disclosure are discussed in detail above. While specific implementations are discussed, it should be understood that this description is for illustration purposes only. A person skilled in the relevant art will recognize that other components and configurations may be used without parting from the spirit and scope of the disclosure. Thus, the description and drawings herein are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various examples given in this specification.

Without intent to limit the scope of the disclosure, examples of machines, components, methods and their related results according to the examples of the present disclosure are given above. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The present disclosure may also reference quantities and numbers. Unless specifically stated, such quantities and numbers are not to be considered restrictive, but exemplary of the possible quantities or numbers associated with the present disclosure. Also in this regard, the present disclosure may use the term “plurality” to reference a quantity or number. In this regard, the term “plurality” is meant to be any number that is more than one, for example, two, three, four, five, etc. As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

While illustrative embodiments have been illustrated and described, it will be appreciated that various changes can be made therein without departing from the spirit and scope of the invention.

While illustrative embodiments have been illustrated and described, it will be appreciated that various changes can be made therein without departing from the spirit and scope of the invention.

The embodiments of the invention in which an exclusive property or privilege is claimed are defined as follows:

1. A beverage packaging component management system for managing beverage packaging component use for a beverage packaging machine, comprising:
a component information system configured to obtain component information from a data storage device of a beverage packaging component and write component information to the data storage device regarding component usage;
a processor; and
a memory storing instructions that, when executed by the processor, cause a computing device of the beverage packaging component management system to:
process component information including at least one of a beverage packaging component type and component usage; and
output a component optimization plan including at least one of recommendations and instructions for using a first type of beverage packaging component for packaging beverages having first beverage packaging requirements, replacing the beverage packaging component, verifying the beverage packaging component on the beverage packaging machine, adjusting one or more beverage packaging components, and adjusting beverage packaging machine settings.

2. The beverage packaging component management system of claim 1, wherein the component information system comprises an RFID reader and an RFID tag secured within the beverage packaging component, the RFID reader positioned relative to the beverage packaging machine to read the RFID tag secured within the beverage packaging component each time the beverage packaging component completes a cycle in the beverage packaging machine.

3. The beverage packaging component management system of claim 1, wherein the component information includes whether the beverage packaging component is can or bottle compatible, can or bottle size compatibility, beverage packaging component manufacturer, machine compatibility, and a beverage packaging component count.

4. The beverage packaging component management system of claim 1, wherein the component optimization plan includes a recommendation to use a first beverage packaging component of a first type and a first wear level to package beverages of a first type, and wherein the component optimization plan includes a recommendation to use a second beverage packaging component of a second type and the first wear level to package beverages of a second type.

5. The beverage packaging component management system of claim 1, wherein the component optimization plan includes at least one of information regarding a part number for ordering a replacement beverage packaging component and instructions for sending to a computing device to automatically order a replacement beverage packaging component.

6. The beverage packaging component management system of claim 1, wherein the component optimization plan includes at least one of information regarding whether a component type and a component wear level is suitable for carrying out packaging of beverages having the first beverage packaging requirements.

7. The beverage packaging component management system of claim 6, wherein the memory storing instructions that, when executed by the processor, further cause a computing device of the beverage packaging component management system to output at least one of recommendations or instructions for adjusting at least one of components and settings of the beverage packaging machine to accommodate the component type and the component wear level.

8. The beverage packaging component management system of claim 6, wherein the memory storing instructions that, when executed by the processor, further cause a computing device of the beverage packaging component management system to execute one or more component optimization machine learning models configured to output at least one of recommendations or instructions for adjusting at least one of components and settings of the beverage packaging machine using the component type and the component wear level as input.

9. The beverage packaging component management system of claim 1, wherein the memory storing instructions that, when executed by the processor, further cause a computing device of the beverage packaging component management system to:
determine if a beverage packaging component count is less than an expected beverage packaging component count for a certain period; and
output instructions to a controller of the beverage packaging machine to at least one of adjust a speed of a beverage packaging component and stop a beverage packaging component if the beverage packaging component count is less than an expected beverage packaging component count for a certain period.

10. The beverage packaging component management system of claim 1, wherein the memory storing instructions that, when executed by the processor, further cause a computing device of the beverage packaging component management system to execute one or more component optimization machine learning models configured to output instructions to a controller of the beverage packaging machine to at least one of adjust a speed of a beverage packaging component and stop a beverage packaging component using an actual component count and an expected component count for a certain period as input.

11. The beverage packaging component management system of claim 1, wherein the memory storing instructions that, when executed by the processor, further cause a computing device of the beverage packaging component management system to execute one or more component optimization machine learning models to output the component optimization plan using at least one of component identification information, component usage data, and beverage packaging needs as input.

12. A method for managing beverage packaging components for a beverage packaging machine, comprising:
obtaining, with a component information system, component information from a data storage device of a beverage packaging component;
writing, with the component information system, component information to the data storage device regarding component usage;
processing, with a computing device, component information including at least one of a component type and component usage; and
outputting, with a computing device, a component optimization plan including at least one of recommendations and instructions for using a first type of beverage packaging component for packaging beverages having first beverage packaging requirements, replacing the beverage packaging component, verifying the beverage packaging component on the beverage packaging machine, adjusting one or more beverage packaging components, and adjusting beverage packaging machine settings.

13. The method of claim 12, further comprising:
reading, with an RFID reader, an RFID tag secured within the beverage packaging component each time the beverage packaging component completes a cycle in the beverage packaging machine; and
writing, with the RFID reader, component usage information pertaining to the beverage packaging component to the RFID tag each time the beverage packaging component completes a cycle in the beverage packaging machine.

14. The method of claim 12, wherein the component optimization plan includes at least one of:
a recommendation to use a first beverage packaging component of a first type and a first wear level to package beverages of a first type and a recommendation to use a second beverage packaging component of a second type to package beverages of a second type;
at least one of information regarding a part number for ordering a replacement beverage packaging component and instructions for sending to a computing device to automatically order a replacement beverage packaging component; and
at least one of information regarding whether a component type and a component wear level is suitable for carrying out packaging of beverages having the first beverage packaging requirements.

15. The method of claim 14, further comprising outputting, with a computing device, at least one of recommendations or instructions for adjusting at least one of components and settings of the beverage packaging machine to accommodate the component type and the component wear level.

16. The method of claim 14, further comprising executing, with a computing device, one or more component optimization machine learning models to output at least one of recommendations or instructions for adjusting at least one of components and settings of the beverage packaging machine to accommodate the component type and the component wear level as input.

17. The method of claim 12, further comprising:
determining, with a computing device, if a component count is less than an expected component count for a certain period; and
outputting, with a computing device, instructions to a controller of the beverage packaging machine to at least one of adjust a speed of the beverage packaging component and stop the beverage packaging component if the component count is less than an expected component count for a certain period.

18. The method of claim 12, further comprising executing, with a computing device, one or more component optimization machine learning models to output instructions to a controller of the beverage packaging machine to at least one of adjust a speed of a beverage packaging component and stop a beverage packaging component using an actual component count and an expected component count for a certain period as input.

19. The method of claim 12, further comprising executing, with a computing device, one or more component optimization machine learning models to output the component optimization plan using at least one of component identification information, component usage data, and beverage packaging needs as input.
